(19) United States
(12) Patent Application Publication
(10) Pub. No.: US 2026/0261792 A1
(43) Pub. Date: Sep. 3, 2026

(54) LOUDSPEAKER AND METHOD FOR SPREADING A SOUND

(71) Applicant: POWERSOFT S.P.A., SCANDICCI (FIRENZE) (IT)

(72) Inventors: CLAUDIO LASTRUCCI, SCANDICCI (FIRENZE) (IT); LEONARDO BRACCIOTTI, SCANDICCI (FIRENZE) (IT); LORENZO LOMBARDI, SCANDICCI (FIRENZE) (IT)

(21) Appl. No.: 19/164,848

(22) PCT Filed: Mar. 22, 2024
(86) PCT No.: PCT/IB2024/052774

§ 371 Date: Sep. 12, 2025

(30) Foreign Application Priority Data
Mar. 24, 2023 (IT) 102023000005709

(51) Int. Cl. H04R 1/22; H04R 9/02; H04R 9/04

(52) U.S. Cl. CPC H04R 1/22; H04R 9/025; H04R 9/046

(57) ABSTRACT

A loudspeaker includes: an active radiator, movable along a longitudinal axis, and a ferromagnetic circuit including: a central core, extending along the longitudinal axis from a first end, proximal to the active radiator, to a second end; an outer core, located on the outside of the central core and separate from the first end of the central core so as to define a gap in which a coil connected to the radiator is movable longitudinally; a main magnet, having the shape of a ring and inserted in the outer core with longitudinally oriented polarization to generate a main magnetic flux, circulating in the ferromagnetic circuit to cross the gap in a crossing direction; a secondary magnet, oriented longitudinally and located at the first end of the central core to generate a secondary magnetic flux that crosses the gap in the crossing direction and closes itself outside the ferromagnetic circuit.

### TECHNICAL FIELD

This invention relates to a loudspeaker and to a method for spreading a sound.

### BACKGROUND ART

Generally speaking, a loudspeaker comprises a ferromagnetic circuit in which there flows a magnetic field generated by a permanent magnet or by a coil which is traversed by current; the loudspeaker comprises a coil or a magnet, which is movable within a gap in the ferromagnetic circuit under the action of the magnetic field and which directly or indirectly drives an (active) radiator whose movement generates the sound. Thus, the ferromagnetic circuit is subdivided by the gap into a central core (inside the gap) and an outer core (outside the gap).

In this context, the prior art teaches that a magnetic flux circulating in the ferromagnetic circuit can be generated by a magnet placed in the outer core; this type of solution is known, for example, from patent documents US2015/0030199A and U.S. Pat. No. 8,135,162B2.

Document US2015/0030199A proposes generating a magnetic field screening effect through an additional magnet (labelled 105 in the drawings) placed under the ferromagnetic circuit and extending under both the central core and the outer core.

The loudspeaker of U.S. Pat. No. 8,135,162B2 proposes to increase the magnetic flux circulating in the ferromagnetic circuit by means of an additional magnet aligned with the main magnet (in the drawings, the two magnets are labelled 104 and 108).

Patent documents U.S. Pat. Nos. 5,461,677A, 7,068,807B2, JPH10112896A and US2016/227325A1 describe other examples of loudspeakers provided with an additional magnet. In document US2016/227325A1, the additional magnet, which is located at the end of the central core proximal to the radiator, is what is known as a bucking magnet, that is, a magnet used to reduce magnetic flux loss; for this purpose, the additional magnet has a polarity opposing the polarity of the magnet positioned in the outer core. Document U.S. Pat. No. 7,068,807B2 also shows an additional magnet whose polarity is the opposite of the polarity of the magnet in the outer core. Document JPH10112896A illustrates an additional magnet placed at the end of the central core proximal to the radiator, inside a recess formed in the central core. This configuration has the disadvantage of increasing the magnetic flux in, and thereby saturating, the central pole, especially in the portions of the central pole close to the gap and to the additional magnet. Document U.S. Pat. No. 5,461,677A relates to a loudspeaker containing a ferrofluid material to cool the loudspeaker; in this case, the additional magnet is used to contain the ferrofluid material in which the coil is immersed. To ensure heat exchange between the coil and the ferrofluid material, the movement of the coil inside the gap must be limited and does not go past the additional magnet. Limiting the movement of the coil, however, has negative effects on the SPL parameter of the loudspeaker (that is, on the quantity of the sound produced). This problem can be avoided by using a larger additional magnet, which, disadvantageously, means increasing the size and costs of the loudspeaker.

In the trade, therefore, there is a need for loudspeakers which are particularly compact (that is, small in size) but which, at the same time, offer particularly high performance.

### DISCLOSURE OF THE INVENTION

This disclosure has for an aim to provide a loudspeaker and a method for spreading a sound to overcome the above-mentioned disadvantages of the prior art.

In particular, the aim of this disclosure is to provide a loudspeaker which is compact and characterized by high performance.

Another aim is to provide a loudspeaker characterized by a frequency response which is particularly extensive and linear.

These aims are fully achieved by the loudspeaker and method for spreading a sound of this disclosure, as characterized in the appended claims.

In particular, the loudspeaker comprises an active radiator which is movable along a longitudinal axis to generate sound waves.

The loudspeaker comprises a ferromagnetic circuit. The ferromagnetic circuit includes a central core, extending along the longitudinal axis. The central core extends from a first end to a second end. The first end is proximal to the active radiator, while the second end is distal to the active radiator.

The ferromagnetic circuit includes an outer core, located outside the central core. The outer core surrounds the longitudinal axis. The outer core, preferably at least one portion of it, is separate from the central core. For example, the outer core is separate from the first end of the central core, so as to define a gap which extends longitudinally. In other words, the outer core is longitudinally separate from the central core so as to define a gap at the first end of the central core.

The loudspeaker comprises a magnetic field generator. The magnetic field generator may be inserted in the outer core or it may be inserted in the inner core. The magnetic field generator is configured to generate a main magnetic flux, circulating in the ferromagnetic circuit, in particular to cross the gap in a crossing direction.

The field generator may be a coil, for example coaxial with the longitudinal axis, that is to say, wound around the longitudinal axis, or a permanent magnet. Preferably, the loudspeaker comprises a permanent magnet, that is, a main magnet.

The main magnet is ring-shaped. The main magnet is inserted in the outer core. The main magnet is configured to generate a main magnetic flux. The main magnetic flux circulates in the ferromagnetic circuit to cross the gap in a crossing direction. Preferably, the main magnet constitutes a break in the outer core. The main magnet has a longitudinally oriented polarization. The main magnetic flux crosses the central core along a crossing orientation.

The loudspeaker comprises a movable element, configured to move along a movement orientation parallel to the longitudinal axis in order to move the active radiator. The movable element may be a coil or a magnet. The movable element is located inside the gap and is preferably coaxial with the longitudinal axis.

Preferably, the loudspeaker comprises a coil which movable along a movement orientation parallel to the longitudinal axis to move the active radiator inside the gap, and which is coaxial with the longitudinal axis.

The loudspeaker comprises a secondary magnet. The secondary magnet is aligned with the longitudinal axis. The secondary magnet is located at the first end of the central core to generate a secondary magnetic flux. The secondary magnetic flux crosses the gap in the crossing direction and closes itself outside the ferromagnetic circuit. Preferably, the secondary magnet has a longitudinally oriented polarization. The secondary magnetic flux crosses the central core along a crossing orientation which is discordant relative to the crossing orientation of the main magnetic flux. That way, the magnetic flux density in the central core decreases.

Preferably, the main magnet and the secondary magnet are longitudinally misaligned.

Thus, the presence of the secondary magnet has the effect of reducing the magnetic flux density in the central core and increasing the magnetic flux density crossing the gap. Under equal condition of magnetic flux crossing the gap, this allows using a main magnet which is smaller, hence less expensive, and reducing the saturation level of the central core, which means that the central core can be made from less noble materials, hence is more economical and may be smaller in size.

In effect, to prevent saturating the central core, other approaches are possible, including that of increasing the size of the central core or using noble materials, characterized by high saturation. Such solutions, however, make the loudspeaker cumbersome and expensive. With this invention, under equal conditions of flux to the gap, the resultant flux in the central core is much lower and can therefore contain the dimensions of the loudspeaker without using expensive, noble materials.

Another effect of the secondary magnet consists in reducing the magnetic flux loss (to the gap), resulting in a more uniform distribution in the gap; consequently, the force generated to move the coil located in the gap is also more symmetrical. It is noted that use of the secondary magnet leads to an increase in the loss outside the loudspeaker. For this reason, an additional, secondary magnet according to the bucking magnet configuration may be used.

In an example, the secondary magnet is placed flush with the central core. In other words, the secondary magnet is circular in shape and its radius, relative to the longitudinal axis, is (substantially) equal to a radius of the central core, measured at the second end of the central core. Use of a secondary magnet whose radius is greater than or less than the radius of the central core is also imaginable.

In an example, the secondary magnet has an underside surface in (direct or indirect) contact with the first end of the central core, and a top surface, opposite the underside surface. The top surface and the underside surface extend in respective extension planes perpendicular to the longitudinal axis. The secondary magnet has an outside surface which extends around the longitudinal axis (that is, which surrounds the longitudinal axis). In particular, the outside surface faces away from the longitudinal axis. A perimetric edge included between the top surface and the outside surface may have a chamfer (to define a chamfered edge); in other words, considering a cross section of the secondary magnet running through the secondary magnet along a plane comprising the longitudinal axis, the secondary magnet may have a trapezoidal cross section. The chamfered edge is advantageous to make it easier for electrical power cables to pass.

Preferably, the first end of the central core extends (exclusively) in an extension plane which is perpendicular to the longitudinal axis. Thus, the underside surface of the secondary magnet is in (direct or indirect) contact with the first end of the central core so as to define a contact surface lying in the extension plane of the central core. The fact that the contact surface lies in the extension plane of the central core (hence that the secondary magnet is not located in a recess of the central core) reduces the risk of saturating the portions of the central core proximal to the secondary magnet and to the gap.

In an example, the secondary magnet has an inside surface, opposite the outside surface, which extends around the longitudinal axis and faces towards the longitudinal axis. Thus, the secondary magnet may be annular in shape, that is, ring-shaped.

In particular, the outer core may comprise an upper portion and a lower portion. The upper portion and the lower portion may be longitudinally aligned with each other. The main magnet may be located between the upper portion and the lower portion of the outer core, along an orientation parallel to the longitudinal axis. The gap is defined by a portion of outside surface of the central core, and a portion of surface of the upper portion and a portion of surface of the main magnet, facing the portion of outside surface of the central core.

Relative to a cross section in a half-plane having the longitudinal axis as its origin, the outer core may have a radial extent which is greater than the radial extent of the central core. In other words, the outer core may extend along the radial orientation to a greater extent than the extent of the central core along the radial orientation, where the radial orientation is defined perpendicularly to the longitudinal axis.

The upper portion is ring-shaped. The upper portion of the outer core has an inside surface which extends around the longitudinal axis and faces towards the longitudinal axis (in other words, which is proximal to the longitudinal axis). The upper portion has an outside surface, opposite the inside surface and extending around the longitudinal axis.

In an example, a ratio between an area Sₜₚ of the inside surface of the upper portion of the outer core and an area Sₚₚ of a radially extending surface of the central core (measured relative to a cross section in a half plane having the longitudinal axis as its origin) is less than or equal to 1.3, in particular 1.6, and more particularly, 2.

The ratio Sₜₚ/Sₚₚ represents a surface of the upper portion of the outer core, crossed by a given magnetic flux, relative to a cross section of the central core, also crossed by a given magnetic flux. With an outer core of the same size, the presence of the secondary magnet allows reducing the cross section of the central core (thus reducing the size of the central core) so as to obtain high performance with limited dimensions and inertias.

The coil is configured to move along a movement orientation preferably parallel to the longitudinal axis. The coil moves along the movement orientation between a first end and a second end, opposite the first. The coil moves along the movement orientation so that the first end (or the second end) moves between a point of maximum and a point of minimum. At the point of maximum, the radiator moves away from the central core, at the point of minimum, the radiator moves towards the central core. In particular, at the point of maximum, the coil comes (completely or partially) out of the gap (in particular, at least one of the two ends of the coil comes out of the gap, more particularly, the first end of the coil comes out of the gap). In particular, at the point of maximum, the first end can move longitudinally past the secondary magnet. In moving between the point of maximum and the point of minimum, the first end (or the second end) of the coil passes through a point of equilibrium, preferably equidistant from the point of maximum and the point of minimum.

Preferably, the coil moves in an air space.

In an example, a ratio between a height Hₚₚ of the inside surface of the upper portion of the outer core and a distance Xₘₐₓ of the first end of the coil between the point of equilibrium and the point of maximum is less than or equal to 2, in particular 1.6, more particularly 1.4 (in particular, the height of the outside surface and the distance between the point of equilibrium and the point of maximum are measured parallel to the longitudinal axis). This ratio represents the coil travel relative to the height of the upper portion of the outer core; the greater the coil travel, the more extended the frequency response of the loudspeaker.

In an example, a ratio between a height Hₚₚ of the inside surface of the upper portion of the outer core and a height H_{vc} of the coil, measured parallel to the longitudinal axis, is greater than or less than 1 (that is to say, different from 1). Preferably, this ratio is less than or equal to 1.5, in particular less than 1.8, more particularly, less than 2. In effect, for good loudspeaker response linearity, it is useful that the height of the coil is significantly less than (or greater than but not almost equal to) the height of the upper portion of the outer core.

In an example, a ratio between a height Hₚₚ of the inside surface of the upper portion of the outer core and a height Hₘ of the main magnet, measured parallel to the longitudinal axis, is less than or equal to 1.55, in particular, less than or equal to 1.7, more particularly, less than or equal to 2. In effect, to obtain high performance while keeping the size reduced, it is useful that the height of the main magnet is limited compared to the height of the upper portion.

In an example, a ratio between a diameter D_{d} of the suspension and a diameter Dₘ of the main magnet is less than or equal to 1.3, in particular less than or equal to 1.13, more particularly, 1.1. In effect, the larger the main magnet relative to the size of the loudspeaker piston, the higher the power of the loudspeaker.

Preferably, relative to a cross section in a half-plane having the longitudinal axis as its origin, the secondary magnet has a radial extent which is equal to a radial extent of the central core. In other words, the secondary magnet does not have portions located at the outer core, that is to say, relative to a cross section in a half-plane having the longitudinal axis as its origin, the secondary magnet does not extend radially at the outer core, that is, it does not extend radially past the central core.

In an example, the secondary magnet is in direct contact with the first end of the central core, or is in contact with the first end of the central core through a zone with high magnetic permeability.

Preferably, the loudspeaker comprises a basket. The basket encloses the ferromagnetic circuit and the coil. The basket has a circular aperture. The radiator is fixed to the basket at the circular aperture (by means of a suspension).

In an example, the gap defines an air space. The loudspeaker comprises a centring element, surrounding the longitudinal axis. The centring element is positioned between the radiator and the upper portion of the outer core. The centring element and a top surface of the upper portion of the core define an air space. The air space defined by the gap and the air space defined by the centring element and by the top surface of the upper portion are in aerial communication.

In an embodiment, the outer core is also separate from the second end of the central core, so as to define an additional gap which extends longitudinally. Preferably, the additional gap is aligned with the gap. In this case, the main magnetic flux crosses the additional gap in an additional crossing direction. Preferably, the additional crossing direction is opposite of the first crossing direction.

The loudspeaker may comprise an additional secondary magnet, aligned with the longitudinal axis and located at the second end of the central core. The additional secondary magnet generates an additional secondary magnetic flux that crosses the additional gap in the additional crossing direction and closes itself outside the ferromagnetic circuit. Preferably, the additional secondary magnet has a longitudinally oriented polarization. The additional secondary magnet and the secondary magnet may be longitudinally aligned with each other. The main magnet may be misaligned with the additional secondary magnet and with the secondary magnet. The additional secondary magnetic flux is configured to cross the central core in the direction opposite of the direction of the main magnetic flux.

The additional secondary magnet may be made with the same characteristics as those described for the secondary magnet.

The loudspeaker may comprise an additional coil, located in the additional gap. The additional coil is coaxial with the longitudinal axis and is movable along an additional movement orientation parallel to the longitudinal axis. Preferably, the additional movement orientation of the additional coil is aligned with the movement orientation of the coil, that is to say, the coil and the additional coil are aligned along the same orientation parallel to the longitudinal axis. The coil and the additional coil may be configured to move along the movement orientation and the additional movement orientation in the same direction or in the opposite direction, respectively.

In particular, the additional gap may be defined by a portion of outside surface of the central core, and a portion of surface of the lower portion and a portion of surface of the main magnet, facing the portion of outside surface of the central core.

The loudspeaker may comprise a cylindrical support surrounding the central core and located in the gap, and the coil may be wound around the cylindrical support, that is to say, it may be integral with the cylindrical support to move together with the cylindrical support. The cylindrical support is connected to the radiator to move the radiator responsive to the movement of the coil along the movement orientation.

In an embodiment, the cylindrical support is located in the additional gap, or it is located in the gap and in the additional gap, and the additional coil may be wound around the cylindrical support, that is to say, it may be integral with the cylindrical support to move together with the cylindrical support. In this case, the coil and the additional coil move along the same movement orientation in the same direction.

In a further embodiment, the loudspeaker comprises an additional active radiator, which is movable along the longitudinal axis to generate sound waves and which is opposite the active radiator; the loudspeaker may comprise an additional cylindrical support surrounding the central core in the additional gap, and the additional coil may be wound around the cylindrical support, that is to say, it may be integral with the additional cylindrical support to move together with the additional cylindrical support. In this case, the coil and the additional coil move along the same movement orientation in the same direction and/or in the opposite direction.

In an example, the central core comprises a cylindrical hole. The cylindrical hole may extend between the first and the second end of the central core. In particular, the cylindrical hole may extend along the longitudinal axis between an inlet and an outlet, at the second end and at the first end of the central core, respectively. The central core may have cylindrical symmetry about the longitudinal axis.

In an example, the loudspeaker comprises power cables for connecting a power supply unit (that is, an amplifier acting as a power supply unit) to the coil. In particular, the cylindrical hole may define a passage which leads the power cables from the inlet to the outlet of the cylindrical hole.

In an example, the loudspeaker may comprise a light diffuser, that is, a dome configured to diffuse light. Preferably, the diffuser is located at the outlet of the cylindrical hole. The light diffuser may protrude towards the active radiator, that is to say, it may be configured to diffuse light towards the active radiator.

The loudspeaker may comprise a dust dome. In an embodiment, the light diffuser may be a dust dome, that is to say, the dust dome is configured to diffuse light. In a further embodiment, the light diffuser may be configured to diffuse the light towards the dust dome, where the dust dome is at least partly transparent to light. Thus, the light diffuser and the dust dome may be one and the same, or the light diffuser and the dust dome may be distinct parts of the loudspeaker. The active radiator may be at least partly transparent to light.

The loudspeaker may comprise a light source configured to emit, that is, to generate light, and preferably located at the inlet of the cylindrical hole. The loudspeaker may comprise a light guide, configured to connect the light source to the light diffuser. That way, the light generated by the light source is diffused towards the active radiator. The light source, the light diffuser and the light guide may constitute a lighting system.

The loudspeaker may comprise an electronic card, preferably comprising a control unit for driving the loudspeaker, that is, the coil. The light source may be connected to the electronic card. The control unit may be programmed to drive the light source.

Thus, the hole is filled with the power cables and the light guide.

It is noted that a lighting system as just described may be applicable to any type of loudspeaker that comprises a cylindrical hole.

Thus, this disclosure also provides a loudspeaker comprising an active radiator movable along a longitudinal axis to generate sound waves and a ferromagnetic circuit, where the ferromagnetic circuit may include a central core, extending along the longitudinal axis from a first end, proximal to the active radiator, to a second end, distal to the active radiator, and an outer core, located outside the central core, surrounding the longitudinal axis and separate from the first end of the central core so as to define a longitudinally extended gap. The loudspeaker (that is, the ferromagnetic circuit) comprises a magnetic field generator, for example, a main coil or a main magnet, configured to generate a main magnetic flux, circulating in the ferromagnetic circuit to cross the gap in a crossing direction. The field generator may be located in the central core or in the outer core. The loudspeaker comprises a movable element, for example, a movable magnet or a coil, located in the gap, coaxial with the longitudinal axis and movable along a movement orientation which is parallel to the longitudinal axis to move the active radiator (directly or indirectly). In this case, the central core comprises a cylindrical hole extending along the longitudinal axis between an inlet and an outlet, at the second end and at the first end of the central core, respectively. The central core may have cylindrical symmetry about the longitudinal axis. The loudspeaker comprises a lighting system. The lighting system may comprise a diffuser configured to diffuse light. The diffuser may have the shape of a dome. Preferably, the diffuser is located at the outlet of the cylindrical hole. The diffuser may protrude towards the active radiator, that is to say, it may be configured to diffuse light towards the active radiator.

The loudspeaker may comprise a dust dome (configured to keep dust out of the interior of the loudspeaker). The light diffuser may protrude towards the dust dome so as to diffuse the light towards the dome. In particular, the dust dome is at least partly transparent to light.

The loudspeaker (that is, the lighting system) may comprise a light source (for example, one or more LEDs) configured to emit light, that is, to generate light. Preferably, the light source is located at the inlet of the cylindrical hole.

The loudspeaker (that is, the lighting system) may comprise a light guide, configured to connect the light source to the light diffuser. That way, the light generated by the light source is diffused towards the active radiator.

The loudspeaker may comprise an electronic card, preferably comprising a control unit for driving the loudspeaker, that is, the coil. The light source may be connected to the electronic card or mounted on the electronic card. The control unit may be programmed to drive (that is, to control) the light source. The control unit may control the light source responsive to an operating condition of the loudspeaker; for example, the control unit may drive the light source to switch it on and/or off responsive to a malfunction of the loudspeaker. Thus, the lighting system may constitute a diagnostic indicator regarding the operation of the loudspeaker. For example, the control unit may be programmed to drive the light source responsive to an electrical signal used to power the coil, that is, it may be programmed to drive the light source based on a sound generated by the loudspeaker.

In an example, the loudspeaker is part of a plurality of loudspeakers comprising the lighting system; for example, the lighting system may be used to provide visible evidence indicating which of the plurality of loudspeakers is emitting a sound.

Preferably, the polarization of the main magnet and of the secondary magnet are concordant with respect to the longitudinal direction. When there is an additional secondary magnet, the polarization of the additional secondary magnet is also concordant with the polarization of the main magnet (hence also of the secondary magnet) along the longitudinal orientation. In other words, the main magnet and the secondary magnet (and the additional secondary magnet, when present) each have a north pole and a south pole, oriented longitudinally in the same direction.

Preferably, the coil has a longitudinal extent that is smaller than the longitudinal extent of the gap, that is to say, the coil is located entirely inside the gap. In other words, the ratio between the longitudinal extent of the gap and the longitudinal extent of the coil is greater than one, that is to say, the gap and the coil constitute an underhung configuration system. In said configuration, the advantages derived from this invention are all the more evident the more the ratio between the extents is greater than one.

When present, the additional coil may have a longitudinal extent that is smaller than the longitudinal extent of the additional gap, that is, the additional coil may be located entirely inside the additional gap.

This disclosure also provides a method for spreading a sound.

The method comprises a step of providing an active radiator which is movable along a longitudinal axis to generate sound waves.

The method comprises a step of providing a ferromagnetic circuit. The ferromagnetic circuit may be made according to one or more of the features described herein. Preferably, the ferromagnetic circuit includes a central core, extending along the longitudinal axis from a first end which is proximal to the active radiator, to a second end which is distal to the active radiator. Preferably, the ferromagnetic circuit includes an outer core, located on the outside of the central core, surrounding the longitudinal axis and separate from the first end of the central core so as to define a longitudinally extended gap. Preferably, the ferromagnetic circuit includes a main magnet which is ring-shaped and inserted in the outer core.

Preferably, the main magnet constitutes a break in the outer core. The main magnet has a longitudinally oriented polarization.

Alternatively to the main magnet, there may be a coil.

The method comprises a step of providing a movable element located inside the gap and coaxial with the longitudinal axis. The movable element may be a magnet or, more preferably, a coil.

The method comprises a step, via the main magnet, of generating a main magnetic flux, circulating in the ferromagnetic circuit to cross the gap in a crossing direction.

The method comprises a step, responsive to the magnetic flux generated, of moving the coil (or the magnet) along a movement orientation parallel to the longitudinal axis to move the active radiator.

The method comprises a step of generating a secondary magnetic flux that crosses the gap in the crossing direction and closes itself outside the ferromagnetic circuit, so that the density of the total flux crossing the gap is greater than the density of the main magnetic flux.

In particular, the secondary magnetic flux closes itself outside the ferromagnetic circuit, crossing the central core in a direction that is the opposite of the direction of the main magnetic flux so that the density of the total flux crossing the gap is greater than the density of the main magnetic flux. At the same time, the density of the flux crossing the central core is less than the density of the main magnetic flux.

The secondary magnetic flux may be generated by a secondary magnet which is aligned with the longitudinal axis and which is located at the first end of the central core. In other words, the method may comprise a step of providing a secondary magnet, aligned with the longitudinal axis and located at the first end of the central core. Preferably, the secondary magnet has a longitudinally oriented polarization.

Preferably, the main magnet and the secondary magnet are longitudinally misaligned.

The secondary magnet may be in contact with the first end of the central core directly or through a zone with high magnetic permeability.

The method may comprise a step of simultaneously magnetizing the main magnet inserted in the outer core and the secondary magnet located at the first end of the central core.

In an example, the outer core is separate from the central core so as to define an additional gap extending longitudinally and aligned with the gap, and the main magnetic flux crosses the additional gap in an additional crossing direction.

The method may comprise a step of providing an additional coil, located in the additional gap, coaxial with the longitudinal axis. The method may comprise a step, responsive to the magnetic flux generated, of moving the additional coil along a movement orientation parallel to the longitudinal axis. The method may comprise a step of generating an additional secondary magnetic flux that crosses the additional gap in the additional crossing direction and closes itself outside the ferromagnetic circuit, so that the density of the total flux crossing the additional gap is greater than the density of the main magnetic flux. In particular, the additional secondary magnetic flux closes itself outside the ferromagnetic circuit, crossing the central core in a direction that is the opposite of the direction of the main magnetic flux so that the density of the total flux crossing the additional gap is greater than the density of the main magnetic flux. The density of the flux crossing the central core is less than the density of the main magnetic flux.

For example, the method may comprise a step of providing an additional secondary magnet, aligned with the longitudinal axis and located at the second end of the central core. In other words, the additional secondary magnetic flux is generated by an additional secondary magnet. Preferably, the additional secondary magnet has a longitudinally oriented polarization. The additional secondary magnet and the secondary magnet may be longitudinally aligned. The main magnet may be longitudinally misaligned with the additional secondary magnet and with the secondary magnet.

In an example of the method, the coil has a longitudinal extent that is smaller than the longitudinal extent of the gap.

### BRIEF DESCRIPTION OF THE DRAWINGS

This and other features will become more apparent from the following description of a preferred embodiment, illustrated by way of non-limiting example in the accompanying drawings, in which:

FIGS. 1A and 2A show a cross section of a loudspeaker 1 according to one or more aspects of this disclosure;

FIGS. 1B and 2B show a cross section of a loudspeaker 1 according to the prior art;

FIG. 3 shows a loudspeaker 1 according to one or more aspects of this disclosure;

FIG. 4 shows an exploded view of a loudspeaker 1 according to one or more aspects of this disclosure;

FIGS. 5A and 5B show a loudspeaker 1 schematically according to one or more aspects of this disclosure;

FIGS. 6A and 6B show a cross section of a loudspeaker 1 according to one or more aspects of this disclosure, comprising a lighting system;

FIGS. 6C-6E show a cross section of a loudspeaker 1 according to one or more aspects of this disclosure, with a radiator at different positions relative to a longitudinal axis;

FIG. 7A illustrates a simulation of the magnetic flux circulating in a loudspeaker 1 according to one or more aspects of this disclosure, and

FIG. 7B illustrates a simulation of the magnetic flux circulating in a loudspeaker of the prior art;

FIGS. 8A and 8B show schematically the magnetic flux directions in a loudspeaker 1 according to one or more aspects of this disclosure;

FIG. 9 shows a cross section of a loudspeaker 1 according to one or more aspects of this disclosure.

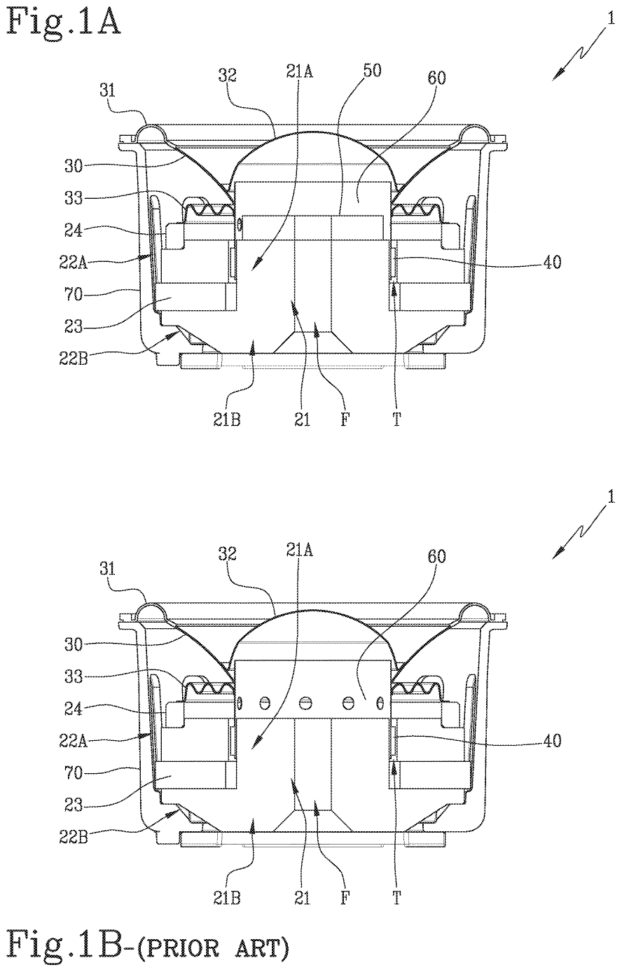

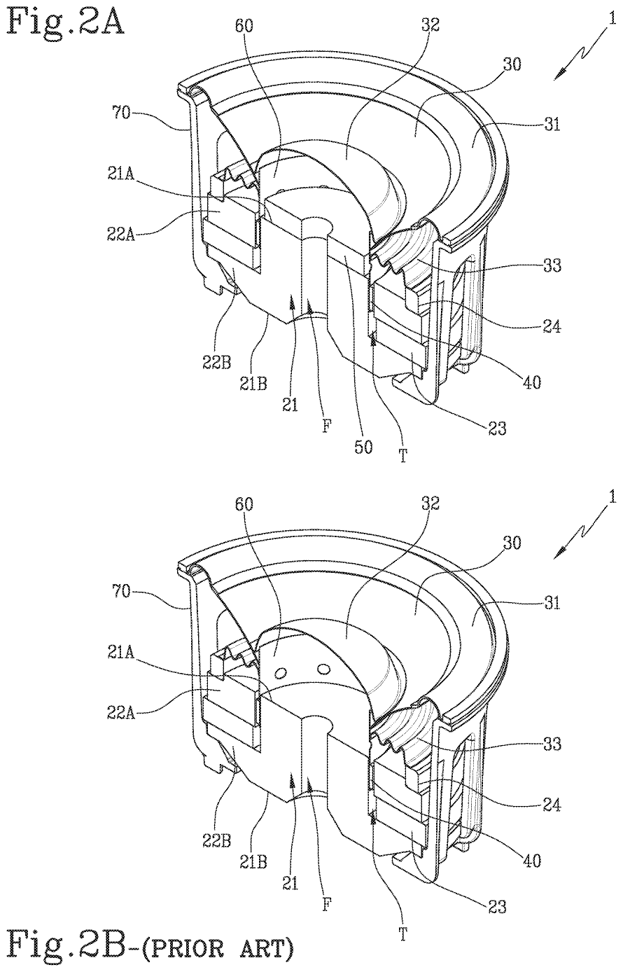

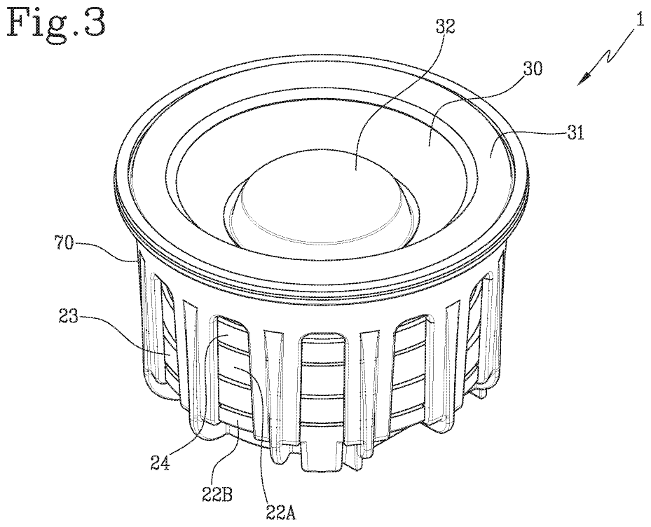

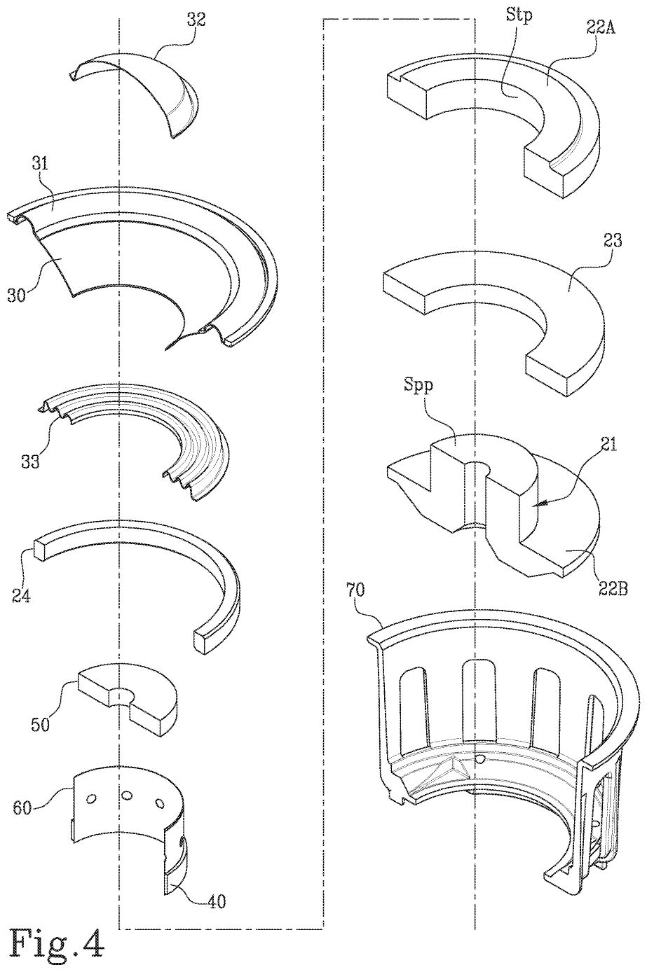

### DETAILED DESCRIPTION OF PREFERRED EMBODIMENTS OF THE INVENTION

The numeral 1 in the accompanying drawings denotes a loudspeaker.

The loudspeaker 1 comprises an active radiator 30, movable along a longitudinal axis X to generate sound waves.

The loudspeaker 1 comprises a ferromagnetic circuit. The ferromagnetic circuit includes a central core 21, extending along a longitudinal axis X from a first end 21A, proximal to the active radiator 30, to a second end 21B distal to the active radiator 30. For example, the central core 21 may be made of iron.

The ferromagnetic circuit includes an outer core 22 located outside the central core 21 and surrounding the longitudinal axis X. For example, the outer core 22 may be made of iron. The outer core 22 includes an upper portion 22A and a lower portion 22B which are longitudinally aligned with each other. The upper portion 22A is separate from the first end of the central core 21 to define a longitudinally extending gap T.

The ferromagnetic circuit includes a ring-shaped main magnet 23 inserted longitudinally in the outer core 22 between the upper portion 22A and the lower portion 22B.

In an embodiment, the lower portion 22B is in direct contact with the central core 21 at the second end 21B; for example, the lower portion 22B may be defined by a lower portion of the second end 21B which extends away from the longitudinal axis X. In this case, the gap T is defined longitudinally by a surface of the upper portion 22A of the outer core 22 and by a portion of inside surface of the central core 21 which face each other.

The main magnet 23 is also separate from the central core 21.

The main magnet 23 generates a main magnetic flux, circulating in the ferromagnetic circuit and crossing the gap T in a crossing direction V. The main magnet 23 comprises a north pole N and a south pole S, oriented longitudinally relative to each other. The north pole N may be in contact with the upper portion 22A of the outer core 22 and the south pole S may be in contact with the lower portion 22B of the outer core 22, or vice versa, that is to say, the north pole N may be in contact with the lower portion 22B of the outer core 22 and the south pole S may be in contact with the upper portion 22A of the outer core 22.

The loudspeaker 1 comprises a coil 40, located in the gap T, coaxial with the longitudinal axis X and movable along a movement orientation M that is parallel to the longitudinal axis X.

Preferably, the coil 40 has a longitudinal extent that is smaller than the longitudinal extent of the gap T, which means the coil 40 is located entirely inside the gap T. In particular, the coil 40 has a longitudinal extent that is smaller than the longitudinal extent of the upper portion 22A of the outer core 22.

The loudspeaker 1 comprises a cylindrical support 60 surrounding the central core 21 and located in the gap T. The coil 40 is wound around the cylindrical support 60 and the cylindrical support 60 moves together with the coil 40 along the movement orientation M. The cylindrical support 60 is connected to the active radiator 30 so as to move the radiator 30 in response to the movement of the coil 40.

The loudspeaker 1 comprises a basket 70 and the radiator 30 is fixed to the basket 70 by means of a suspension 31. The loudspeaker 1 comprises a dust dome 32 fixed to the radiator 30.

The loudspeaker 1 comprises a guide system. In the examples illustrated, the guide system is a centring element 33 connected to the cylindrical support 60 and configured to keep the cylindrical support 60, hence also the coil 40, centred in the gap T during the movement.

The centring element 33 may be connected to the stationary structure by a support ring 24.

In an example not illustrated, the guide system may be made according to what is disclosed by patent document 102022000026061 in the name of the present Applicant and incorporated herein by reference.

The loudspeaker 1 comprises a secondary magnet 50, located at the first end 21A of the central core 21 and aligned with the longitudinal axis X. The secondary magnet 50 is in direct contact with the first end 21A of the central core 21.

The secondary magnet 50 is configured to generate a secondary magnetic flux which crosses the gap T in the crossing direction V and closes itself outside the ferromagnetic circuit.

The polarization of the main magnet 23 and that of the secondary magnet 50 are concordant relative to the longitudinal orientation, that is to say, the main magnet 23 and the secondary magnet 50 each have a north pole N and a south pole S, oriented longitudinally in the same direction.

The main magnet 23, the secondary magnet 50, the central core 21 and the outer core 22 define a stationary structure of the loudspeaker 1, while the coil 40, the cylindrical support 60 and the radiator 30 define a movable working unit.

In an embodiment, the lower portion 22B is separate from the second end 21B of the central core 21 to define an additional gap T′, extending longitudinally. In this case, the additional gap T′ is defined longitudinally by a surface of the lower portion 22B of the outer core 22 and by a portion of inside surface of the central core 21 which face each other.

Thus, the magnetic flux generated by the main magnet 23 also crosses the additional gap in an additional crossing direction. The loudspeaker 1 may comprise an additional coil 40′, located in the additional gap T′, coaxial with the longitudinal axis X and movable along an additional movement orientation M′ that is parallel to the longitudinal axis X and preferably coincides with the movement orientation M of the coil 40. The additional coil 40′ may have a longitudinal extent that is smaller than the longitudinal extent of the additional gap T′, which means the additional coil 40′ is located entirely inside the additional gap T′. In particular, the additional coil 40′ may have a longitudinal extent that is smaller than the longitudinal extent of the lower portion 22B of the outer core 22.

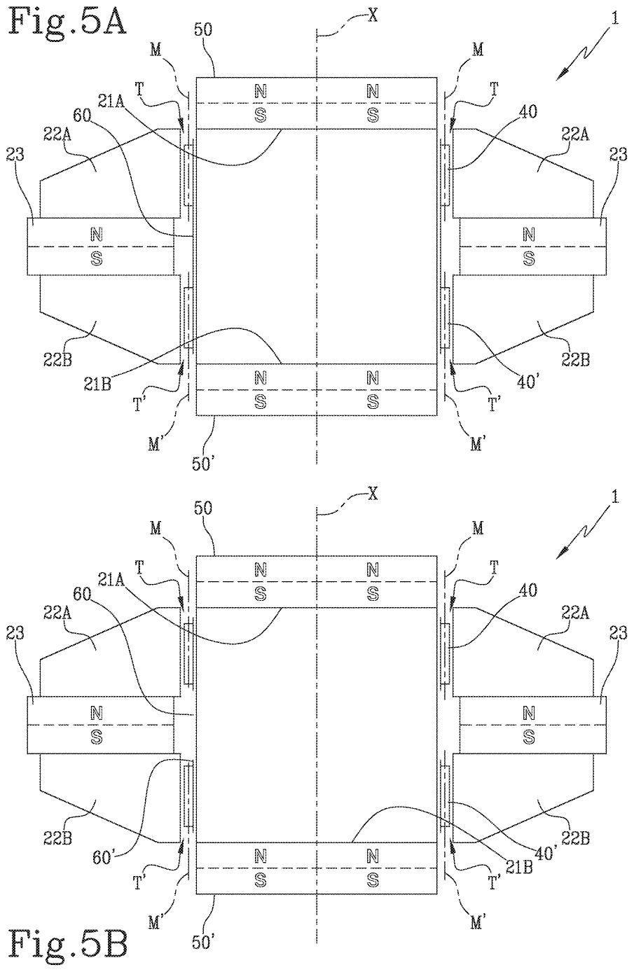

In an embodiment illustrated purely by way of example in FIG. 5A, the cylindrical support 60 extends longitudinally up to the additional gap T′ and the additional coil 40′ is wound around the cylindrical support 60 to move as one with the cylindrical support and the coil 40; in this case, therefore, the movement orientation and the movement direction coincide.

In another embodiment, illustrated purely by way of example in FIG. 5B, the loudspeaker 1 comprises an additional cylindrical support 60′, which locates the central core 21 and is located in the additional gap T′. The additional coil 40′ is wound around the additional cylindrical support 60′ and therefore, the additional cylindrical support 60′ moves as one with the additional coil 40′ along the additional movement orientation M′; in this case, the additional cylindrical support 60′ may be connected to an additional active radiator so as to move the additional active radiator responsive to the movement of the additional coil 40′. In this case, preferably, the movement orientations M and M′ of the coil 40 and additional coil 40′ coincide but the movement directions may be the same or opposite. The additional radiator may be fixed to the basket 70 by an additional suspension and the loudspeaker 1 may comprise an additional dust dome fixed to the additional radiator. The loudspeaker 1 may then comprise an additional centring element, connected to the additional cylindrical support 60′ and configured to keep the additional cylindrical support 60′, hence also the additional coil 40′, centred in the additional gap T′ during the movement. The loudspeaker 1 may comprise an additional secondary magnet 50′, located at the second end 21B of the central core 21 and aligned with the longitudinal axis X. The additional secondary magnet 50′ is in direct contact with the second end 21B of the central core 21.

The additional secondary magnet 50′ is configured to generate an additional secondary magnetic flux which crosses the additional gap T′ in an additional crossing direction V and closes itself outside the ferromagnetic circuit.

The polarizations of the main magnet 23, of the secondary magnet 50 and of the additional secondary magnet 50′ are concordant relative to the longitudinal orientation, that is to say, the main magnet 23, the secondary magnet 50 and the additional secondary magnet 50′ each have a north pole N and a south pole S, oriented longitudinally in the same direction.

The central core 21 may comprise a cylindrical hole F. The cylindrical hole extends along the longitudinal axis X between an inlet and an outlet, at the second end 21B and at the first end 21A of the central core 21, respectively. The cylindrical hole F may define a passage which leads power cables 80 of the coil 40 (and of the additional coil 40′, if present) from the inlet to the outlet of the cylindrical hole F.

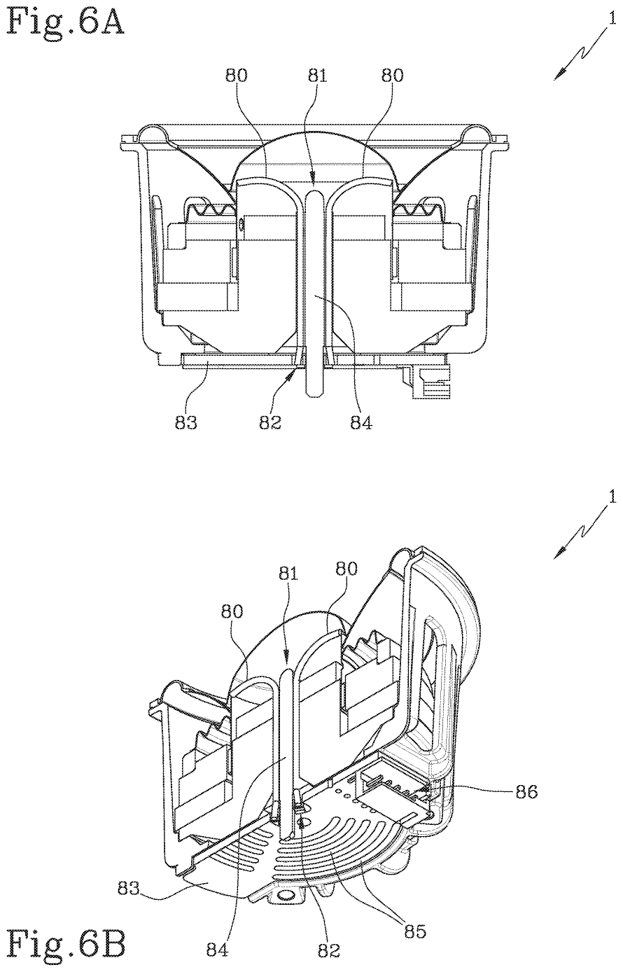

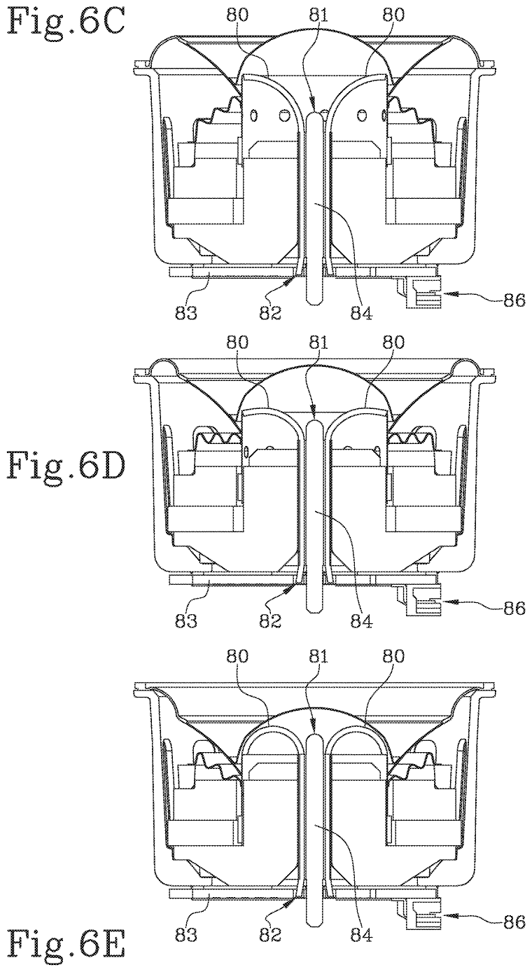

In FIGS. 6A and 6B, a loudspeaker 1 comprising a lighting system is shown by way of example. The lighting system comprises a light diffuser 81, having the shape of a dome and located at the outlet of the cylindrical hole F to diffuse light towards the dust dome 32, where the dust dome is partly transparent to light. The lighting system comprises a light source 82 to generate light. The loudspeaker 1 may comprise an electronic card 83, comprising a control unit programmed to drive the loudspeaker 1. The light source 82 may be located on the electronic card 83 and controlled by the control unit. The light source 82 is located at the inlet of the cylindrical hole F. The lighting system comprises a light guide 84, configured to connect the light source 82 to the light diffuser 81.

The electronic card 83 may comprise a memory, preferably accessible to the control unit of the electronic card 83. The memory may be accessible to a control unit outside the loudspeaker 1. The memory may contain information representing the loudspeaker 1. The information may be contained in the memory in an encrypted form. The information may include a serial number (identifying the loudspeaker 1) and/or a batch number (identifying a plurality of loudspeakers comprising the loudspeaker 1) and/or a production facility where the loudspeaker 1 was made and/or other information. The information may include a plurality of electromechanical parameters relating to the loudspeaker 1. For example, the electromechanical parameters may describe features or specifications typical of the loudspeaker 1 (in numeric form, in tabular form or in matrix form), for example, the information may comprise a movable mass value, and/or a resonance frequency value, and/or a variation in a force factor as a function of coil position, and/or an inductance as a function of frequency and coil position, and/or other features.

The information contained in the memory may be accessible to an external control unit, for example, to control the functions of the loudspeaker 1.

In an example, the electronic card 83 comprises a plurality of conductive tracks 85. The conductive tracks 85 may be configured to carry an electrical signal, that is, a signal to be transduced into an audio signal, and/or an electrical power supply. The conductive tracks 85 may be configured to carry the electrical power supply, for example to the light source and/or to the memory.

The electronic card 83 comprises a connector 86 for receiving electrical power from a power supply unit, that is an amplifier acting as a power supply unit.

FIGS. 6C, 6D and 6E illustrate an operating sequence of the loudspeaker 1. As the coil 40 moves along the movement orientation (that is, along the longitudinal axis X), the radiator 30, which is connected (indirectly) to the coil 40, also moves along the longitudinal axis X.

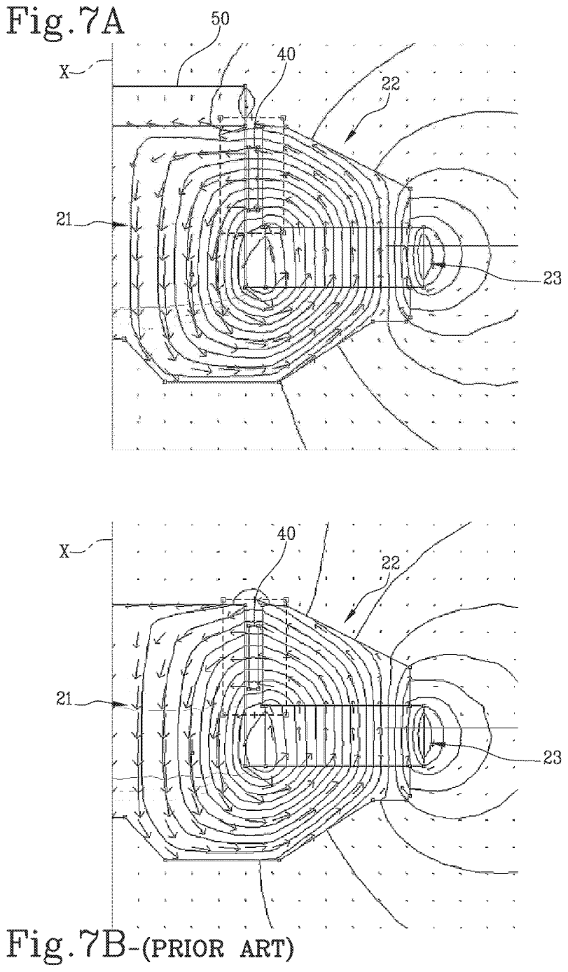

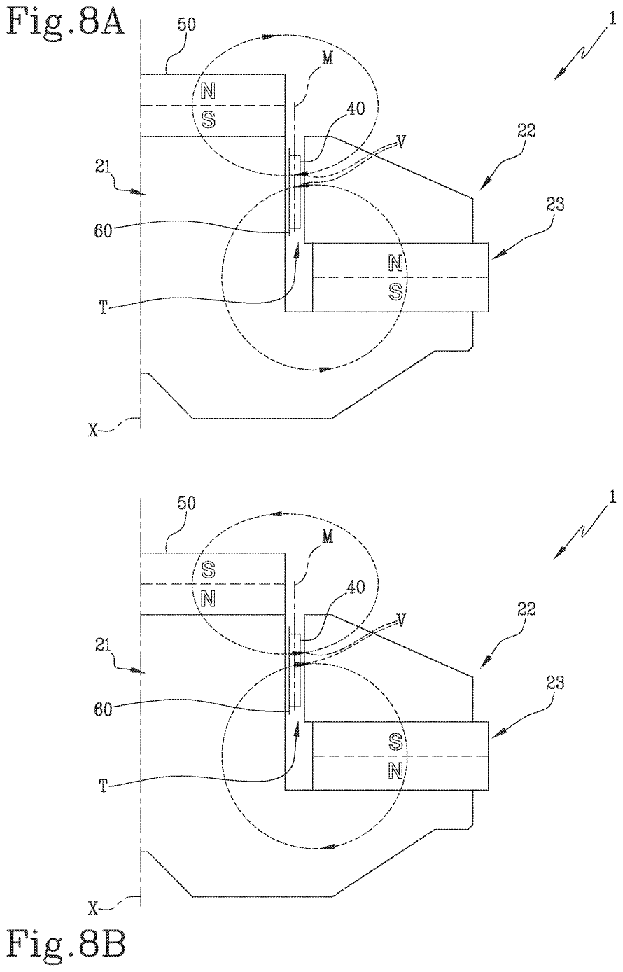

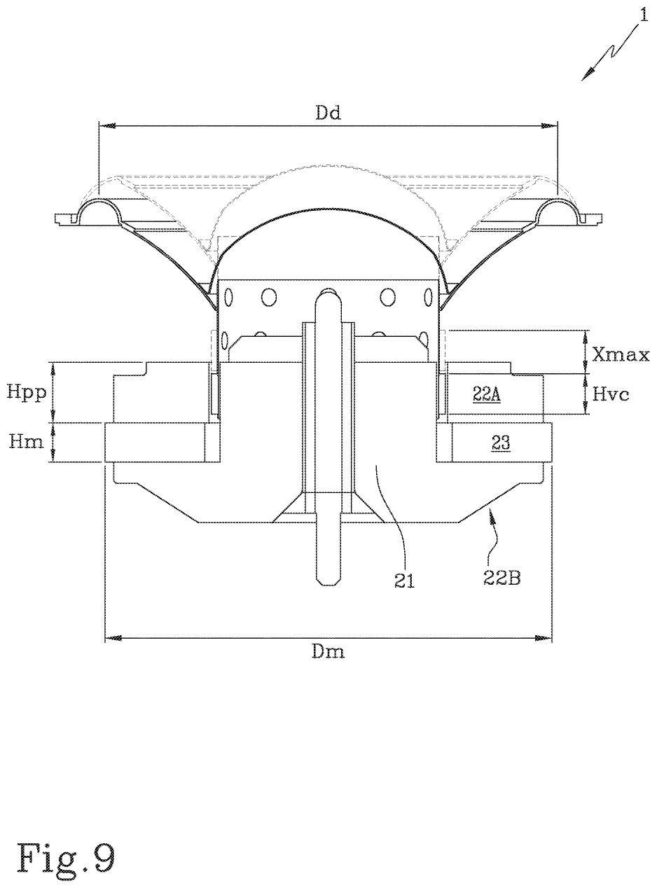

FIGS. 7A and 7B illustrate the pattern of the magnetic flux in a loudspeaker 1 according to this invention and a loudspeaker 1 according to the prior art, respectively.

1. A loudspeaker, comprising:
an active radiator, movable along a longitudinal axis to generate sound waves;
a ferromagnetic circuit, including:
a central core, extending along the longitudinal axis from a first end, proximal to the active radiator, to a second end distal to the active radiator;
an outer core, located on the outside of the central core, surrounding the longitudinal axis and separate from the first end of the central core so as to define a longitudinally extended gap,
a main magnet, having the shape of a ring and inserted in the outer core with longitudinally oriented polarization to generate a main magnetic flux, circulating in the ferromagnetic circuit to cross the gap in a crossing direction;
a coil, located in the gap, coaxial with the longitudinal axis and movable along a movement orientation that is parallel to the longitudinal axis to move the active radiator
wherein it comprises a secondary magnet, aligned with the longitudinal axis and located at the first end of the central core to generate a secondary magnetic flux that crosses the gap in the crossing direction and closes itself outside the ferromagnetic circuit.

2. The loudspeaker according to claim 1, wherein the secondary magnet is in contact with the first end of the central core directly or through a zone with high magnetic permeability.

3. The loudspeaker according to claim 1, wherein the outer core is further separated from the second end of the central core so as to define an additional gap extending longitudinally and aligned with the gap, the main magnetic flux crossing the additional gap in an additional crossing direction, the loudspeaker comprising:
an additional secondary magnet, aligned with the longitudinal axis and located at the second end of the central core to generate an additional secondary magnetic flux that crosses the additional gap in the additional crossing direction and closes itself outside the ferromagnetic circuit,
an additional coil, located in the additional gap, coaxial with the longitudinal axis and movable along an additional movement orientation that is parallel to the longitudinal axis.

4. The loudspeaker according claim 1, wherein the central core comprises a cylindrical hole extending along the longitudinal axis between an inlet and an outlet at the second end and at the first end of the central core, respectively, the central core being cylindrically symmetric about the longitudinal axis.

5. The loudspeaker according to claim 4, comprising power cables, configured to connect an amplifier to the coil, wherein the cylindrical hole defines a passage for the power cables from the inlet to the outlet of the cylindrical hole.

6. The loudspeaker according to claim 4, comprising:
a light diffuser, located at the outlet of the cylindrical hole and protruding towards the active radiator;
a light source, located at the inlet of the cylindrical hole and configured to generate light;
a light guide, configured to connect the light source to the light diffuser so as to diffuse the light generated by the light source towards the active radiator.

7. The loudspeaker according to claim 1, wherein the polarization of the main magnet and that of the secondary magnet concordant relative to the longitudinal orientation.

8. The loudspeaker according to claim 1, wherein the coil has a longitudinal extent that is smaller than the longitudinal extent of the gap.

9. The loudspeaker according to claim 1, wherein the outer core comprises an upper portion and a lower portion, which are longitudinally aligned with each other, the main magnet being located between the upper portion and the lower portion along an orientation parallel to the longitudinal axis, the upper portion being ring-shaped and having an inside surface which extends around the longitudinal axis and faces towards the longitudinal axis.

10. The loudspeaker according to claim 9, wherein a ratio between an area Sₜₚ of the inside surface of the upper portion of the outer core and an area Sₚₚ of a radially extending surface of the central core is less than or equal to 1.6.

11. The loudspeaker according to claim 9, wherein a ratio between a height Hₚₚ of the inside surface of the upper portion of the outer core and a height Hₘ of the main magnet, measured longitudinally, is less than or equal to 1.7.

12. The loudspeaker according claim 9, wherein a ratio between a height Hₚₚ of the inside surface of the upper portion of the outer core and a height H_{vc} of the coil, measured longitudinally, is different from 1.

13. The loudspeaker according to claim 9, wherein:
the coil extends longitudinally between a first end, proximal to the radiator, and a second end, opposite the first end, the coil being configured to move within the gap so that the first end moves between a point of maximum, where the radiator moves away from the central core, and a point of minimum, where the radiator moves towards the central core, and wherein, in moving between the point of maximum and the point of minimum, the first end (or the second end) of the coil passes through a point of equilibrium;
a ratio between a height Hₚₚ of the inside surface of the upper portion of the outer core and a distance Xₘₐₓ between the point of equilibrium and the point of maximum is less than or equal to 1.6.

14. The loudspeaker according to claim 1, comprising a basket and a suspension, the radiator being fixed to the basket via the suspension, wherein a ratio between a diameter D_{d} of the suspension and a diameter Dₘ of the main magnet is less than or equal to 1.13.

15. A method for spreading a sound, comprising the following steps:
providing an active radiator, movable along a longitudinal axis to generate sound waves;
providing a ferromagnetic circuit, including:
a central core, extending along the longitudinal axis from a first end, proximal to the active radiator, to a second end distal to the active radiator;
an outer core, located on the outside of the central core, surrounding the longitudinal axis and separate from the first end of the central core so as to define a longitudinally extended gap,
a main magnet, having the shape of a ring and inserted in the outer core with longitudinally oriented polarization;
providing a coil, located in the gap and coaxial with the longitudinal axis;
via the main magnet, generating a main magnetic flux, circulating in the ferromagnetic circuit to cross the gap in a crossing direction;
responsive to the magnetic flux generated, moving the coil along a movement orientation parallel to the longitudinal axis to move the active radiator,
wherein it comprises a step of generating a secondary magnetic flux that crosses the gap in the crossing direction and closes itself outside the ferromagnetic circuit, so that the density of the total flux crossing the gap is greater than the density of the main magnetic flux.

16. The method according to claim 15, comprising a step of providing a secondary magnet, aligned with the longitudinal axis and located at the first end of the central core.

17. The method according to claim 16, wherein the secondary magnet is in contact with the first end of the central core directly or through a zone with high magnetic permeability.

18. The method according to claim 16, comprising a step of simultaneously magnetizing the main magnet inserted in the outer core and the secondary magnet located at the first end of the central core.

19. The method according to claim 15, wherein the outer core is separate from the central core so as to define an additional gap extending longitudinally and aligned with the gap, and the main magnetic flux crosses the additional gap in an additional crossing direction, the method comprising the following steps:
providing an additional coil, located in the additional gap and coaxial with the longitudinal axis;
responsive to the magnetic flux generated, moving the additional coil along an additional movement orientation parallel to the longitudinal axis,
generating an additional secondary magnetic flux that crosses the additional gap in the additional crossing direction and closes itself outside the ferromagnetic circuit, so that the density of the total flux crossing the additional gap is greater than the density of the main magnetic flux.

20. The method according to claim 19, comprising a step of providing an additional secondary magnet, aligned with the longitudinal axis and located at the second end of the central core.

21. The method according to claim 15, wherein the coil has a longitudinal extent that is smaller than the longitudinal extent of the gap.
